(19) United States
(12) Patent Application Publication
(10) Pub. No.: US 2012/0292429 A1
(43) Pub. Date: Nov. 22, 2012

(54) Discoidal Seaplane

(76) Inventor: Wendell Olson, San Francisco, CA (US)

(21) Appl. No.: 13/460,851

(22) Filed: May 1, 2012

Related U.S. Application Data
(60) Provisional application No. 61/481,364, filed on May 2, 2011.

(51) Int. Cl. B64C 37/00

(52) U.S. Cl. 244/2

(57) ABSTRACT

A flying vehicle, comprising a discoidal secondary wing and two airfoil primary wings. The airfoil primary wings provide out-of-surface-effect lift that acts as the main lift force for the vehicle. The discoidal secondary wing provides lift via the surface effect, stabilizes the vehicle, provides a mounting surface for solar panels, and acts as a pontoon for water landings. The vehicle can also include a retractable toroidal or round balloon to provide additional lift. The vehicle is fully scalable, from children's toys to passenger vehicles.

### CROSS-REFERENCE TO RELATED APPLICATIONS

The present application claims the benefit of U.S. provisional patent application No. 61/481,364, filed May 2, 2011, which is incorporated herein by reference in its entirety.

### FIELD OF THE INVENTION

The invention pertains to aircraft designed to fly at a low altitude, and specifically to discoidal-shaped aircraft designed to fly over water.

### BACKGROUND OF THE INVENTION

The concept of surface effect flight is well known in the art of aviation. An aircraft utilizing surface effect becomes airborne by developing dynamic air pressure between the vehicle and a surface, sufficient to maintain sustained flight near the surface. Such aircraft are typically used to fly over water, since unlike dry land, the surface of a body of water is near-perfectly flat and offers no unexpected obstacles to a low-flying aircraft.

While many surface-effect vehicles have the appearance of conventional winged aircraft—a central fuselage with wings extending on either side—there are disadvantages to the winged design. For example, if the aircraft tilts and the tip of a wing touches the water's surface, the aircraft may crash. Thus, many alternative designs have been developed, generally combining the surface-effect wing with another means of supporting the aircraft and preventing tipping. Several such designs use a hovercraft function in combination with the surface-effect wing, which enables the aircraft to take off and land vertically, but which adds complexity to the design. U.S. Pat. No. 5,464,069 to Gifford discloses such a design.

Other designs take advantage of the forward motion of the aircraft for both the surface effect and for conventional lifting force. U.S. Pat. No. 5,727,495 to Reslein discloses a surface effect vehicle that also includes an airfoil spaced above the vehicle body that provides additional lifting force and stabilizes the aircraft. However, due to the small size of the aircraft, there is a limitation on how much lift it can develop. Furthermore, because of the small size of the surface-effect wing, the aircraft is vulnerable to tipping.

### SUMMARY OF THE INVENTION

A primary object of the present invention is to provide a new and improved flying vehicle that utilizes surface effect for part of its lifting force and that does not require a hovercraft function to remain in the air.

A further object of the present invention is to provide a vehicle with a discoidal secondary wing that provides lift via the surface effect and furthermore acts to stabilize the aircraft, as well as at least one primary wing that provides out of surface effect lifting force in response to the forward motion of the vehicle.

In accordance with the preferred embodiment of the present invention, there is provided a vehicle with a discoidal secondary wing and two double-layer primary wings disposed above the secondary wing. The vehicle is also equipped with propellers or similar means of enabling forward motion, driven by electric motors, internal combustion engines, or other means known in the art.

The discoidal secondary wing serves several functions. One function is to provide surface effect lifting force to assist in lifting the aircraft. Another function is to stabilize the vehicle and prevent flipping when landing, taking off, or just settled in the water. For that purpose, the discoidal secondary wing is equipped with various control features to keep it stable, including but not limited to controllable flaps or gyroscopes. The discoidal secondary wing can also be built in such a way as to enable the vehicle to float when in water, thus serving as a pontoon. Furthermore, due to its large surface area, the discoidal secondary wing can also serve as a mount for solar panels.

In the preferred embodiment, the primary wings are double-layered; each wing has two airfoils, one above the other, slightly staggered to maximize lift force. This provides more lift force than a single-layered wing, as well as a lower profile, to allow an unobstructed view for the passengers.

Another embodiment of the invention also includes a helium or hot-air balloon, or a plurality of balloons, to assist in lifting the vehicle. The balloon or balloons are retractable so that they can be stowed when not in use. When the vehicle is in the air, the balloon or balloons can be deployed and inflated. The balloon or balloons can be any shape, though the preferred embodiment is a toroidal balloon concentric with the axis of the discoidal secondary wing, attached to the discoidal secondary wing by cords or wires. Another embodiment is a spherical balloon located directly above the cabin.

The vehicle is fully scalable; it can be built in any size, ranging from children's toys to full-scale passenger vehicles. As a full-size passenger vehicle, it can attain the speed of 70 miles per hour while flying at a height of 5-10 feet.

### LIST OF FIGURES

FIG. 1 shows a view of the preferred embodiment of the flying vehicle.

FIG. 2 shows a side view of the preferred embodiment of the flying vehicle.

FIG. 3 shows a zoomed-in view of the primary wings.

FIG. 4 shows a view of an alternate embodiment of the flying vehicle.

### DETAILED DESCRIPTION OF THE PREFERRED EMBODIMENT

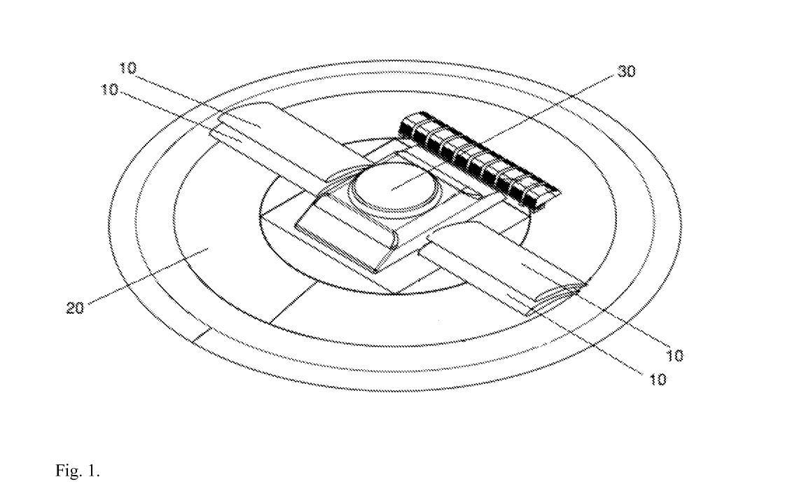

FIG. 1 shows a view of the preferred embodiment of the flying vehicle. Primary wings 10 are located above discoidal secondary wing 20. Cabin 30 is located at the center of the discoidal secondary wing 20, and offers a 360° view to the cabin occupants. The discoidal secondary wing 20 provides lift force via the surface effect, stabilizes the vehicle, acts as a pontoon when the vehicle lands, and provides a mounting surface for solar panels. The discoidal secondary wing also offers the aesthetic advantage of being a “flying saucer”, which is important for recreational flights.

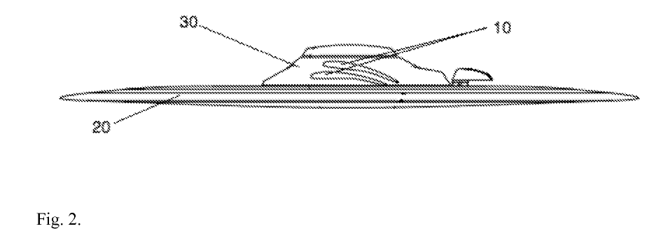

FIG. 2 shows a side view of the flying vehicle, showing the discoidal secondary wing 20, the cabin 30, and the primary wings 10. The cabin 30 is not integrated into the discoidal secondary wing 20, but rather is a separate entity; this increases the strength of the discoidal secondary wing and allows for a modular design, easy change out of modules, and with alternative configurations of cabins, and easier emergency egress from the main body using the cabin or sub-structure of the cabin.

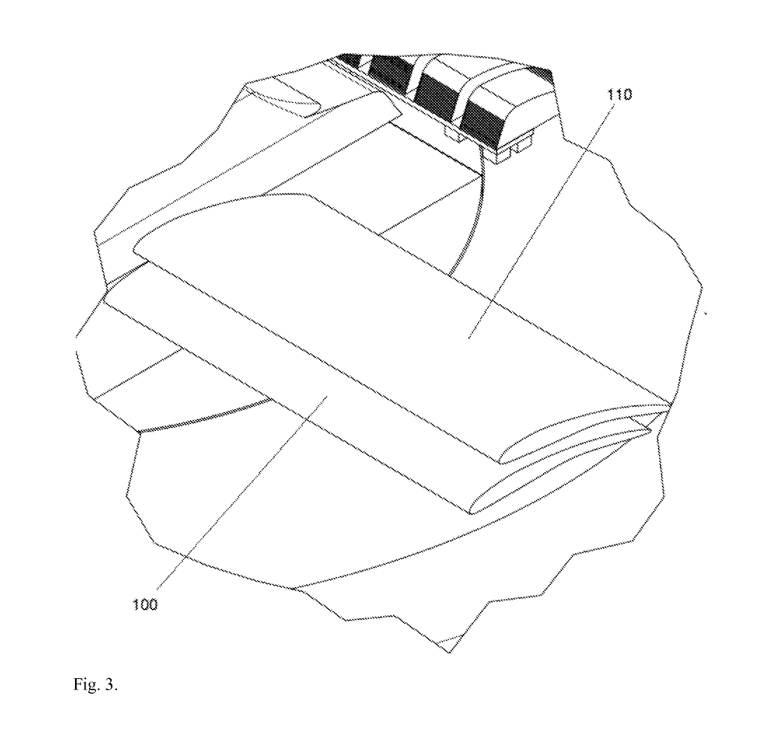

FIG. 3 shows the placement of the primary wings in more detail. The lower airfoil 100 is slightly horizontally displaced from the upper airfoil 110. This maximizes the lift force generated by each airfoil.

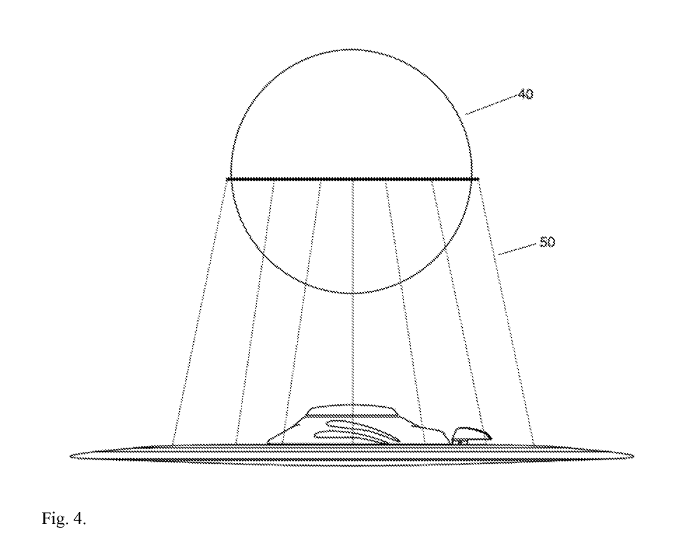

FIG. 4 shows an alternate embodiment of the flying vehicle, showing balloon 40 attached by cables 50 to the flying vehicle. Balloon 40 is a spherical balloon that can be filled with helium, hot air, or any other gas that can provide lift. While the Figure shows a spherical balloon, other balloon shapes are also possible, such as a toroidal balloon. The balloon can also be retractable into the body of the flying vehicle when not in use.

1. A flying vehicle, comprising:
a discoidal secondary wing that utilizes surface effect to provide lift force and stabilizes the flying vehicle;
at least one primary wing located above the discoidal secondary wing, said primary wing providing lift force.

2. The flying vehicle of claim 1, comprising two primary wings.

3. The flying vehicle of claim 1, where the discoidal secondary wing comprises means of stabilizing the vehicle to prevent tipping.

4. The flying vehicle of claim 1, where the discoidal secondary wing comprises controllable flaps to prevent tipping.

5. The flying vehicle of claim 1, where the discoidal secondary wing comprises a gyroscope to prevent tipping.

6. The flying vehicle of claim 1, further comprising a balloon structure located above the discoidal secondary wing.

7. The flying vehicle of claim 1, where the balloon structure is retractable into the discoidal secondary wing when not needed.

8. The flying vehicle of claim 1, where the balloon structure is toroidal in shape and concentric with the discoidal secondary wing.

9. The flying vehicle of claim 1, where each primary wing comprises two airfoils, a top airfoil and a bottom airfoil.

10. The flying vehicle of claim 9, where the top airfoil is slightly horizontally displaced from the bottom airfoil.

11. The flying vehicle of claim 1, where the discoidal secondary wing is usable for flotation.

12. The flying vehicle of claim 1, further comprising a solar panel located on the upper exposed surface of the discoidal secondary wing.
